(19) United States
(12) Patent Application Publication
(10) Pub. No.: US 2004/0096183 A1
(43) Pub. Date: May 20, 2004

(54) Driving device for optical-fiber handicraft

(76) Inventor: Song-Po Shih, Shenzhen (CN)

Correspondence Address: Raymond Y. Chan, Suite 128, 108 N. Ynez Ave., Monterey Park, CA, 91754, US

(21) Appl. No.: 10/633,866

(22) Filed: Aug. 5, 2003

(30) Foreign Application Priority Data
Nov. 15, 2002 (CN) 02249505.3

(51) Int. Cl. G02B 6/00

(52) U.S. Cl. 385/147

(57) ABSTRACT

A driving device for optical-fiber handicrafts includes a base, an electromotor mounted in the base and a plurality of optical-fiber holes defined on a ceiling of the base, a plurality of optical-fiber pipes respectively located aligningly to the optical-fiber holes, a driving setting on the outer-top surface of the base actively connected to the optical-fiber pipes, and an axle defining on the electromotor and actively connected to the driving setting to drive the optical-fiber pipes regularly moving.

### BACKGROUND OF THE PRESENT INVENTION

1. Field of Invention

The present invention relates to a driving device, and more particularly to a driving device for optical-fiber handicrafts having decorative and dynamic display effects with high reliability.

2. Description of Related Arts

A conventional optical-fiber handicraft generally uses focus lamp and lighting film driven by an electromotor to produce dynamic color light. The color light passes through a number of optical fibers to produce dynamic color blinking points at the ends of the optical fibers to stimulate one's visual sensation so as to have decoration effect and entertainment. However, with the advancing of technology and product development, conventional optical-fiber handicraft has limited structure and functions to meet the requirement of consumers. Hence, a new optical-fiber handicraft with a driving device is required to overcome the above problems of the related art.

### SUMMARY OF THE PRESENT INVENTION

A main object of the present invention is to provide a driving device for optical-fiber handicrafts having dynamic visual effects and dynamic mechanical display functions.

Another object of the present invention is to provide a driving device for optical-fiber handicrafts which can work with various kinds of components so as to have more visual and vivid dynamic displays.

Another object of the present invention is to provide a driving device for optical-fiber handicrafts which have novel, simple, rational and reliable structure without intervening the motion of the original mechanism.

Accordingly, in order to accomplish the above objects, the present invention provides a driving device comprising:

a base, wherein a containing cavity is defined therewithin;

an electromotor securely contained in said containing cavity of said base;

a plurality of optical-fiber holes defined on a ceiling of said base;

a plurality of optical-fiber pipes located aligningly to each of said optical-fiber holes respectively;

a driving setting located at said ceiling of said base, wherein said driving setting is moveably connected to said optical-fiber pipes; and

an axle extends from said electromotor and actively connected to said driving setting to drive said optical-fiber pipes moving regularly.

The electromotor comprises an axle actively connected to the driving setting. The driving setting comprises a sliding driving member secured on the top surface of the base and a pair of driving levers each respectively extending from the side surface of the optical-fiber pipes. The sliding driving member comprises a sliding track, a sliding cover actively connecting with the axle of the electromotor and sliding along the sliding track, and a columnar section extending upwardly at the middle of the sliding cover. Each driving lever defines a sliding groove and the two grooves are crosslink connecting by the columnar section. When the electromotor works, the axle of the electromotor can drive the sliding cover of the sliding driving member to move forward and rearward along the sliding track. And then, the columnar section of the sliding cover can move in the two grooves of the driving levers and drive the optical-fiber pipes regularly moving.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a driving device for optical-fiber handicrafts in accordance with the present invention.

### DETAILED DESCRIPTION OF THE PREFERRED EMBODIMENT

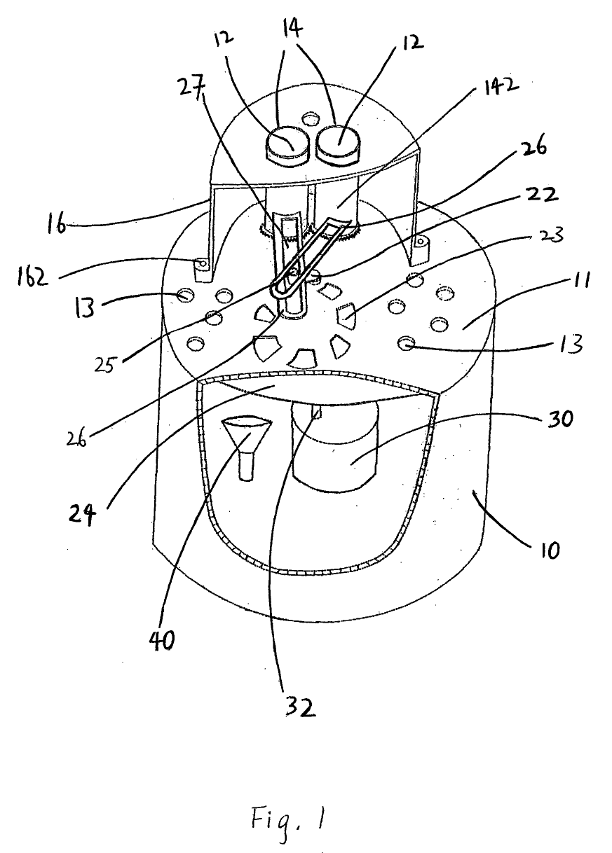

Referring to FIG. 1 of the drawings, a driving device 1 according to a preferred embodiment of the present invention is illustrated, wherein the driving device for optical-fiber handicraft includes a base 10, an electromotor 30 mounted to the base 10 and a driving setting on a top surface 11 of the base 10.

A plurality of optical-fiber holes 12 is defined in the base 10. A pair of rotatable optical-fiber pipes 14 are located in such a manner that each of the optical-fiber pipes 14 is aligned with one of the optical-fiber holes 12 respectively and restrained by a retainer 16 which is fixed on the base 10 through a plurality of restricting pegs 162. The electromotor 30 comprises an axle 32 moveably connected to the driving setting. The driving setting comprises a sliding driving member 22 secured on the top surface 11 of the base 10 and a pair of driving levers 26 each respectively extending from the side surface 142 of the optical-fiber pipes 14. The sliding driving member 22 comprises a sliding track 23, a sliding cover 24 moveably connecting with the axle 32 of the electromotor 30 and sliding along the sliding track 23, and a columnar section 25 extending upwardly at the middle of the sliding cover 24. A sliding groove 27 is defined within each driving lever 26 and the two grooves 27 are crosslink connecting by the columnar section 25. When the electromotor 30 is in action, the axle 32 of the electromotor 30 drives the sliding cover 24 of the sliding driving member 22 to forwardly and rearwardly move along the sliding track 23. The columnar section 25 of the sliding cover 24 then move in the two grooves 27 of the driving levers 26 and drive the optical-fiber pipes 14 regularly moving. A plurality of heat-emitting holes 13 is also defined on the surface of the base 10 to emit heat made by the focus lamp 40.

When assembling the driving device 1 into an optical-fiber handicraft (not shown) and inserting optical fibers (not shown) into the optical-fiber pipes 14, turning on power, the optical-fiber handicraft will work. The lighting film (not labeled) is irradiated by the focus lamp and driven by an electromotor to produce dynamic color light. The color light passes through a number of optical fibers to produce dynamic color blinking points at the ends of the optical fibers to stimulate one's visual sensation so as to have decoration effect and entertainment. By this way, the optical-fiber handicraft will not only have decoration effect, but also enjoy the dynamic display effect because of the mechanical driving setting driven by the electromotor 30.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A driving device for optical-fiber handicrafts, comprising:
a base, wherein a containing cavity is defined therewithin;
an electromotor securely contained in said containing cavity of said base;
a plurality of optical-fiber holes defined on a ceiling of said base;
a plurality of optical-fiber pipes located aligningly to each of said optical-fiber holes respectively;
a driving setting located at said ceiling of said base, wherein said driving setting is moveably connected to said optical-fiber pipes; and
an axle extends from said electromotor and actively connected to said driving setting to drive said optical-fiber pipes moving regularly.

2. The driving device for optical-fiber handicrafts, as recited in claim 1, wherein said driving setting comprises a sliding driving member secured on said ceiling of said base, a first driving lever and a second driving lever, wherein said first and second driving levers extend from a side surface of each of said optical-fiber pipes respectively.

3. The driving device for optical-fiber handicrafts, as recited in claim 2, wherein said sliding driving member comprises a sliding track, a sliding cover moveably connecting to said axle of said electromotor and sliding along said sliding track.

4. The driving device for optical-fiber handicrafts, as recited in claim 3, wherein said first and second driving levers has a first sliding groove and a second sliding groove defined therewithin respectively, wherein said first driving lever is on top of the second driving lever in a crossing manner, defining a groove intersection point, wherein said first and second driving levers are connected at said groove intersection point by a columnar section extending upwardly at a middle of said sliding cover.

5. The driving device for optical-fiber handicrafts, as recited in claim 1, wherein said base comprises a retainer mounted on an outer top surface thereof and restraining a pair of said optical-fiber pipes wherein each of said pair of said optical-fiber pipes are located aligningly to said optical-fiber holes respectively.

6. The driving device for optical-fiber handicrafts, as recited in claim 1, wherein said ceiling of said base further has a plurality of heat-emitting holes defined thereon.
